(19) United States
(12) Patent Application Publication
(10) Pub. No.: US 2024/0121741 A1
(43) Pub. Date: Apr. 11, 2024

(54) Methods, Network Function Nodes and Computer Readable Media for Event Subscription Management

(71) Applicant: Telefonaktiebolaget LM Ericsson (publ), Stockholm (SE)

(72) Inventors: David Castellanos Zamora, Madrid (ES); Yunjie Lu, Shanghai (CN); Jesús Ángel De Gregorio Rodriguez, Boadilla del Monte, Madrid (ES); Emiliano Merino Vazquez, Leganés, Madrid (ES)

(21) Appl. No.: 18/277,044

(22) PCT Filed: Feb. 15, 2021
(86) PCT No.: PCT/CN2021/076651

§ 371 Date: Aug. 11, 2023

(51) Int. Cl. H04W 60/00; H04W 48/02

(52) U.S. Cl. CPC H04W 60/00; H04W 48/02

(57) ABSTRACT

The present disclosure provides methods for event subscription management in a network comprising a set of NF nodes, and corresponding NF nodes. The method implemented at a first NF node includes receiving a subscription request of an event for a user equipment, UE, from a third NF node; transmitting, to a second NF node that serves the UE, a subscription report request for the event for the UE; receiving, from a fourth NF node that currently serves the UE, a UE registration request for the UE, including an indication indicating whether the UE is in a restricted service area; and determining whether to transmit a notification for the event to the third NF node based on the UE registration request. The present disclosure further discloses a corresponding method implemented at the second NF node. The present disclosure further provides corresponding computer readable medium.

### TECHNICAL FIELD

The present disclosure generally relates to the technical field of telecommunication, and particularly to methods and Network Function (NF) nodes for event subscription management in a network comprising a set of NF nodes and corresponding computer readable medium.

### BACKGROUND

This section is intended to provide a background to the various embodiments of the technology described in this disclosure. The description in this section may include concepts that could be pursued, but are not necessarily ones that have been previously conceived or pursued. Therefore, unless otherwise indicated herein, what is described in this section is not prior art to the description and/or claims of this disclosure and is not admitted to be prior art by the mere inclusion in this section.

In Fifth Generation (5G) networks, a Network Slice is introduced as a logical network that provides specific network capabilities and network characteristics. An instance of a network slice (e.g. a network slice instance, NSI) is a set of Network Function (NF) instances and the required resources (e.g., computing, storage, and networking resources) which form a deployed Network Slice. An NF is a 3GPP adopted or 3GPP defined processing function in a network, which has defined functional behavior and 3GPP defined interfaces. An NF can be implemented either as a network element on dedicated hardware, a software instance running on a dedicated hardware, or as a virtualized functional instantiated on an appropriate platform, e.g., on a cloud infrastructure.

Among the NFs, a UDM (Unified Data Management) is defined, which functions to manage subscription from other NFs in the network. As per service definition in 3GPP 29.502, the following service has been defined: Nudm_EventExposure: this service allows NF consumers to subscribe to receive an event, and provide monitoring indication of the event to the subscribed NF consumers.

3GPP network allows 5G Core NFs to subscribe to UE reachability event for different purposes: deliver an SMS, request Location Information, deliver Voice over IP calls, etc.

A given NF can request to be notified when the User Equipment (UE) is reachable, so that downlink data or different services can be routed to/from the UE. This subscription is done via UDM, which requests AMF to notify any UE activity detected (e.g. periodic registration update).

The notification sent by AMF can be done in two different ways, depending on the scenario. In particular, the AMF needs to register in UDM by sending UECM registration service request, or update an existing registration (e.g. due to PEI/IMEI change) by sending UECM registration update. If UDM is aware that a NF consumer (also known as service related entity) has requested to be notified about UE reachability, UDM will send a notification (UE reachable) so that the service related entity can contact the UE (e.g. to deliver an SMS).

This is described in 3GPP TS 23.502:

“When the UDM receives the Namf_EventExposure_Notify service operation (SUPI, UE-Reachable) message or Nudm_UECM_Registration service from AMF for a UE that has URRP-AMF information flag set in the UDM, it triggers appropriate notifications to the NFs associated with the URRP-AMF information flag and have subscribed to the UDM for UE Reachability notifications.”

Additionally, 3GPP TS 23.501 has defined a new 5G Core Network (5GC) feature named “service area restrictions” as follows:

“In a Non-Allowed Area a UE is service area restricted based on subscription. The UE and the network are not allowed to initiate Service Request, or any connection requests for user plane data, control plane data, or SM signalling (except for PS Data Off status change reporting) to obtain user services that are not related to mobility (both in CM-IDLE and in CM-CONNECTED states).”

It can be seen so far, the UDM who monitors indication of the event to the subscribed NF consumers is not aware when the UE is in a restricted service area. The UDM thus may trigger wrong notification to the subscribed NF consumers.

### SUMMARY

At least some objects of the present disclosure are to provide technical solutions capable of allowing NF service consumers to be aware whether the UE is available for services.

According to a first aspect of the present disclosure, there is provided a method implemented at a first network function node for managing event subscription. The method includes receiving a subscription request of an event for a user equipment, UE, from a third NF node; transmitting, to a second NF node that serves the UE, a subscription report request for the event for the UE; receiving, from a fourth NF node that currently serves the UE, a UE registration request for the UE, including an indication indicating whether the UE is in a restricted service area; and determining whether to transmit a notification for the event to the third NF node based on the UE registration request.

In an exemplary embodiment, determining whether to transmit a notification for the event to the third NF node based on the UE registration request comprises transmitting a notification for the event to the third NF node when the UE registration request indicates that the UE is in an allowed service area.

In an exemplary embodiment, determining whether to transmit a notification for the event to the third NF node based on the UE registration request comprises prohibiting the transmission of the notification for the event to the third NF node when the UE registration request indicates that the UE is in a restricted service area or that a service area restriction is unknown for the UE.

In an exemplary embodiment, the method further comprises receiving, from the fourth NF node, an update indication indicating that the UE is in an allowed service area; and transmitting a notification for the event to the third NF node.

In an exemplary embodiment, the method further comprises setting a flag indicating that the UE is in a restricted service area when the UE registration request indicates that the UE is in a restricted service area; and processing subsequent requests related to terminating services towards the UE at least partially based on the flag.

In an exemplary embodiment, the method further comprises clearing the flag when receiving, from the fourth NF node, an update indication indicating that the UE is in an allowed service area.

In an exemplary embodiment, the method further comprises transmitting, to the fourth NF node, an indication indicating that the first NF node supports a service area restriction status feature.

In an exemplary embodiment, the event is a UE reachability event.

In an exemplary embodiment, the first NF node is a Unified Data Management, UDM, node, the second and fourth NF nodes are an Access and Mobility Management Function, AMF, node, and the third NF node is a Network Exposure Function, NEF, node.

In an exemplary embodiment, the fourth NF node is the second NF node when no change of serving NF node occurs due to UE mobility, and the fourth NF node is different from the second NF node when a change of serving NF node occurs due to UE mobility.

In an exemplary embodiment, the UE registration request is Nudm_UECM_registration.

In an exemplary embodiment, the update indication is Nudm_UECM_update.

According to a second aspect of the present disclosure, there is provided a method implemented at a first network function node for managing event subscription. The method comprises receiving, from a second NF node that serves a User Equipment, UE, a UE registration request including an indication indicating that service area restriction information for the UE is unknown; and checking whether there is service area restriction information for the UE.

In an exemplary embodiment, the method further comprises checking whether there is a subscription request of an event for the UE from a third NF node in response to there is no service area restriction information for the UE; and transmitting a notification for the event to the third NF node.

In an exemplary embodiment, the method further comprises, in response to there is service area restriction information for the UE, transmitting, to the second NF node, an indication indicating that the first NF node supports service area restriction status feature; receiving, from the second NF node, an update indication indicating whether the UE is in a restricted service area; and determining whether to transmit a notification for an event for the UE to a third NF node based on the update indication.

In an exemplary embodiment, determining whether to transmit a notification for the event for the UE to a third NF node based on the update indication comprises transmitting a notification for the event to the third NF node when the update indication indicates that the UE is in an allowed service area.

In an exemplary embodiment, determining whether to transmit a notification for the event for the UE to a third NF node based on the update indication comprises prohibiting the transmission of the notification for the event to the third NF node when the update indication indicates that the UE is in a restricted service area.

In an exemplary embodiment, the method further comprises receiving, from the second NF node, an update indication indicating that the UE is in an allowed service area; and transmitting a notification for the event to the third NF node.

In an exemplary embodiment, the method further comprises setting a flag indicating that the UE is in a restricted service area when the update indication indicates that the UE is in a restricted service area; and processing subsequent requests related to terminating services towards the UE at least partially based on the flag.

In an exemplary embodiment, the method further comprises clearing the flag when receiving, from the second NF node, an update indication indicating that the UE is in an allowed service area.

In an exemplary embodiment, the method further comprises transmitting, to the second NF node, an indication indicating that the first NF node supports a service area restriction status feature.

In an exemplary embodiment, the event is a reachability event.

In an exemplary embodiment, the first NF node is a Unified Data Management, UDM, node, and the second NF node is an Access and Mobility Management Function, AMF, node.

In an exemplary embodiment, the UE registration request is Nudm_UECM_registration.

In an exemplary embodiment, the update indication is Nudm_UECM_update.

According to a third aspect of the present disclosure, there is provided a method implemented at a second network function node for managing event subscription. The method includes receiving a UE registration request originated from a User Equipment, UE; receiving, from a first NF node, a subscription report request of an event for the UE; determining whether the UE is in a restricted service area; and transmitting, to the first NF node, a UE registration request for the UE, including an indication indicating whether the UE is in a restricted service area.

In an exemplary embodiment, determining whether the UE moves from an allowed service area to a restricted service area; and transmitting an update indication to the first NF node indicating that the UE is in the restricted service area when it is determined that the UE moves from the allowed service area to the restricted service area.

In an exemplary embodiment, the method further comprises determining whether the UE moves from a restricted service area to an allowed service area; and transmitting an update indication to the first NF node indicating that the UE is in the allowed service area when it is determined that the UE moves from the restricted service area to the allowed service area.

In an exemplary embodiment, the method further comprises receiving from the first NF node an indication indicating that the first NF node supports a service area restriction status feature, and the transmitting, to the first NF node, the update indication, including an indication indicating whether the UE is in a restricted service area or in an allowed service area, is performed in response to a determination that the first NF node supports the service area restriction status feature.

In an exemplary embodiment, the event is a reachability event.

In an exemplary embodiment, the first NF node is a Unified Data Management, UDM, node, and the second NF node is an Access and Mobility Management Function, AMF, node.

In an exemplary embodiment, the UE registration request is Nudm_UECM_registration.

In an exemplary embodiment, the update indication is Nudm_UECM_update.

According to a fourth aspect of the present disclosure, there is provided a method implemented at a second network function node for managing event subscription. The method includes receiving, from a first NF node, a subscription report request of an event for a User Equipment, UE; and transmitting, to the first NF node, a UE registration request for the UE, the UE registration request including an indication indicating that service area restriction information for the UE is unknown.

In an exemplary embodiment, the method further comprises receiving, from the first NF node, an indication indicating that the first NF node supports a service area restriction status feature and service area restriction information for the UE; determining whether the UE is in a restricted service area based on the service area restriction information; and transmitting to the first NF node an update indication indicating whether the UE is in a restricted service area.

In an exemplary embodiment, the method further comprises determining whether the UE moves from an allowed service area to a restricted service area; and transmitting an update indication to the first NF node indicating that the UE is in the restricted service area when it is determined that the UE moves from the allowed service area to the restricted service area.

In an exemplary embodiment, the method further comprises determining whether the UE moves from a restricted service area to an allowed service area; and transmitting an update indication to the first NF node indicating that the UE is in the allowed service area when it is determined that the UE moves from the restricted service area to the allowed service area.

In an exemplary embodiment, transmitting, to the first NF node, the update indication, including an indication indicating whether the UE is in a restricted service area or in an allowed service area, is performed in response to a determination that the first NF node supports the service area restriction status feature.

In an exemplary embodiment, the event is a reachability event.

In an exemplary embodiment, the first NF node is a Unified Data Management, UDM, node, and the second NF node is an Access and Mobility Management Function, AMF, node.

In an exemplary embodiment, the UE registration request is Nudm_UECM_registration.

In an exemplary embodiment, the update indication is Nudm_UECM_update.

According to fifth aspect of the present disclosure, a first NF node is provided, comprising: a communication interface arranged for communication, at least one processor, and a memory comprising instructions which, when executed by the at least one processor, cause the first NF node to perform the first and/or second aspects said above.

According to sixth aspect of the present disclosure, a second NF node is provided, comprising: a communication interface arranged for communication, at least one processor, and a memory comprising instructions which, when executed by the at least one processor, cause the second NF node to perform the third and/or fourth aspects said above.

According to seventh aspect of the present disclosure, there is provided a computer program comprising instructions which, when executed by at least one processor, cause the at least one processor to carry out the methods for event subscription management as discussed previously.

According to eighth aspect of the present disclosure, there is provided a carrier containing the computer program discussed above, wherein the carrier is one of an electronic signal, optical signal, radio signal, or computer readable storage medium.

According to the above technical solutions of the present disclosure, the first NF node (e.g., UDM) is provided with information about whether the UE is available for services, and would not notify the NEF even if the UE activity occurs when the UE is not available for services, thereby avoiding wrong delivery attempts from the NEF which otherwise would be caused when the NEF was notified the UE's reachability.

It allows UDM to prohibit terminating services at early stages, both in 5GC system and other accesses while the UE is camping in a restricted service area. This early stage detection allows to save a substantial amount of useless signalling for terminating service requests which otherwise would fail anyway. It also allows operators to quickly check and monitor in UDM those users which are currently camping in not allowed areas, instead of accessing each AMF in the network and checking the information.

### BRIEF DESCRIPTION OF THE DRAWINGS

The objects, advantages and characteristics of the present disclosure will be more apparent, according to descriptions of preferred embodiments in connection with the drawings, on which:

FIG. 1 illustrates one example of a wireless communication system in which embodiments of the present disclosure may be implemented;

FIG. 2 illustrates a wireless communication system represented as a 5G network architecture composed of core NFs;

FIG. 3 illustrates a 5G network architecture using service-based interfaces between the NFs in the control plane, instead of the point-to-point reference points/interfaces used in the 5G network architecture of FIG. 2;

FIG. 4 illustrates a scenario where a UE reachability is requested and a service area restriction is deployed in the network;

FIG. 5 illustratively shows a flowchart of a method for managing event subscription according to an exemplary embodiment of the present disclosure;

FIG. 6 illustratively shows a flowchart of a method for managing event subscription according to an exemplary embodiment of the present disclosure;

FIG. 7 shows an exemplifying signaling diagram illustrating details of the methods schematically illustrated in FIGS. 5 and 6;

FIG. 8 illustratively shows a flowchart of a method for managing event subscription according to an exemplary embodiment of the present disclosure;

FIG. 9 illustratively shows a flowchart of a method for managing event subscription according to an exemplary embodiment of the present disclosure;

FIG. 10 shows an exemplifying signaling diagram illustrating details of the methods schematically illustrated in FIGS. 8 and 9;

FIG. 11 illustratively shows a schematic structure diagram of a first NF node according to an exemplary embodiment of the present disclosure;

FIG. 12 illustratively shows a schematic structure diagram of a first NF node according to an exemplary embodiment of the present disclosure;

FIG. 13 illustratively shows a schematic structure diagram of a second NF node according to an exemplary embodiment of the present disclosure; and

FIG. 14 illustratively shows a schematic structure diagram of a second NF node according to an exemplary embodiment of the present disclosure.

It should be noted that throughout the drawings, same or similar reference numbers are used for indicating same or similar elements; various parts in the drawings are not drawn to scale, but only for an illustrative purpose, and thus should not be understood as any limitations and constraints on the scope of the present disclosure.

### DETAILED DESCRIPTION

Hereinafter, the principle and spirit of the present disclosure will be described with reference to illustrative embodiments. Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. Additional information may also be found in references as follows:
1) 3GPP 23.501, V16.6.0 (2020-09),
2) 3GPP 23.502, V16.6.0 (2020-09),
3) 3GPP 29.503, V16.6.0 (2020-12), and
4) 3GPP 29.505, V16.5.0 (2020-12).

References in this specification to “one embodiment,” “an embodiment,” “an example embodiment,” etc. indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of the skilled in the art to affect such feature, structure, or characteristic in connection with other embodiments whether or not explicitly described.

The terminology used herein is for the purpose of describing particular embodiments only and is not intended to be liming of exemplary embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

The techniques described herein may be used for various wireless communication networks such as Code Division Multiple Access (CDMA), Time Division Multiple Access (TDMA), Frequency Division Multiple Access (FDMA), Orthogonal Frequency Division Multiple Access (OFDMA), Single Carrier-Frequency Division Multiple Access (SC-FDMA), Long Term Evolution (LTE), New Radio (NR) and other networks developed in the future. The terms “network” and “system” are sometimes used interchangeably. For illustration only, certain aspects of the techniques are described below for the 5^{th} generation of wireless communication network. However, it will be appreciated by the skilled in the art that the techniques described herein may also be used for other wireless networks such as LTE and corresponding radio technologies mentioned herein as well as wireless networks and radio technologies proposed in the future.

As used herein, the term “UE” may be, by way of example and not limitation, a User Equipment (UE), a SS (Subscriber Station), a Portable Subscriber Station (PSS), a Mobile Station (MS), a Mobile Terminal (MT) or an Access Terminal (AT). The UE may include, but not limited to, mobile phones, cellular phones, smart phones, or personal digital assistants (PDAs), portable computers, image capture terminal devices such as digital cameras, gaming terminal devices, music storage and playback appliances, wearable terminal devices, vehicle-mounted wireless terminal devices and the like. In the following description, the terms “UE”, “terminal device”, “mobile terminal” and “user equipment” may be used interchangeably.

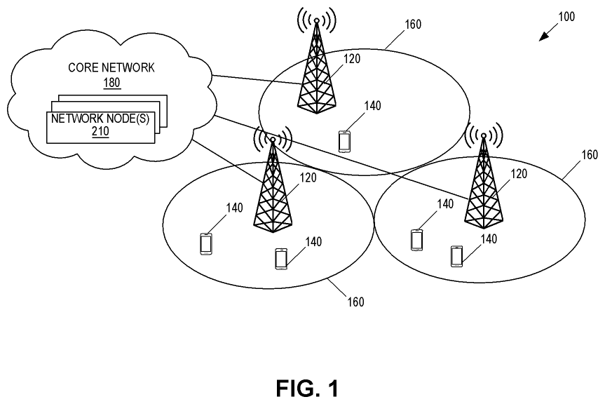

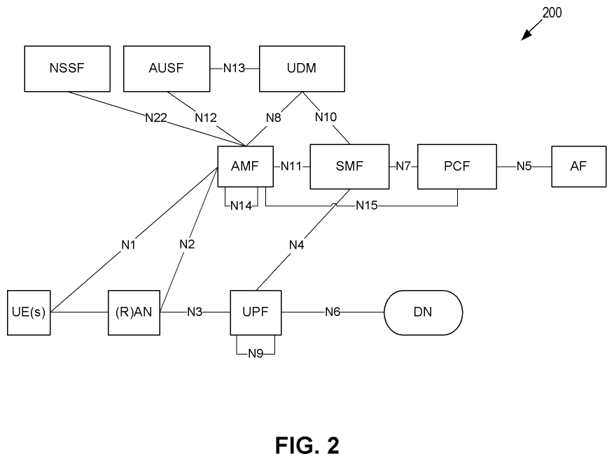

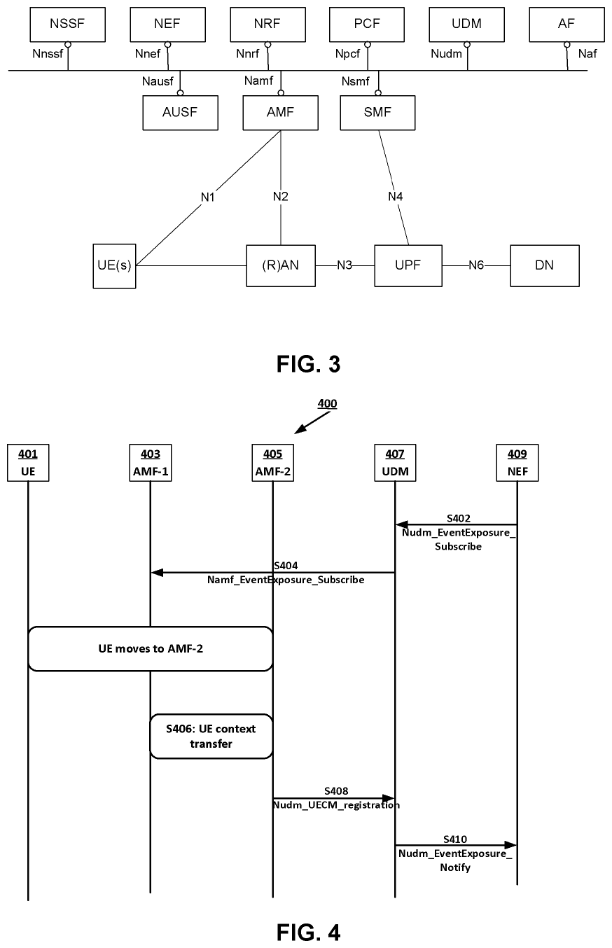

FIG. 1 illustrates one example of a wireless communication system 100 in which embodiments of the present disclosure may be implemented. The wireless communication system 100 may be a cellular communications system such as, for example, a 5G New Radio (NR) network or an LTE cellular communications system. As illustrated, in this example, the wireless communication system 100 includes a plurality of radio access nodes 120 (e.g., evolved Node B:s (eNBs), 5G base stations which are referred to as gNBs, or other base stations or similar) and a plurality of wireless communication devices 140 (e.g., conventional UEs, Machine Type Communication (MTC)/Machine-to-Machine (M2M) UEs). The wireless communication system 100 is organized into cells 160, which are connected to a core network 180 via the corresponding radio access nodes 120. The radio access nodes 120 are capable of communicating with the wireless communication devices 140 (also referred to herein as communication device 140 or UEs 140) along with any additional elements suitable to support communication between wireless communication devices or between a wireless communication device and another communication device (such as a landline telephone). The core network 180 includes one or more network node(s) or function(s) 210. In some embodiments, the network nodes/functions 210 may comprise, for example, any of the network functions shown in FIGS. 2-3.

FIG. 2 illustrates a wireless communication system 200 represented as a 5G network architecture composed of core NFs, where interaction between any two NFs is represented by a point-to-point reference point/interface.

Seen from the access side the 5G network architecture shown in FIG. 2 comprises a plurality of User Equipment (UEs) connected to either a Radio Access Network (RAN) or an Access Network (AN) directly as well as an Access and Mobility Management Function (AMF) indirectly, for example, via the RAN or AN. Typically, the R(AN) comprises base stations, e.g. such as evolved Node Bs (eNBs) or 5G base stations (gNBs) or similar. Seen from the core network side, the 5G core NFs shown in FIG. 2 include a Network Slice Selection Function (NSSF), an Authentication Server Function (AUSF), a Unified Data Management (UDM), an Access and Mobility Management Function (AMF), a Session Management Function (SMF), a Policy Control Function (PCF), an Application Function (AF), and a User Plane Function (UPF).

Reference point representations of the 5G network architecture are used to develop detailed call flows in the normative standardization. The N1 reference point is defined to carry signaling between UE and AMF. The reference points for connecting between AN and AMF and between AN and UPF are defined as N2 and N3, respectively. There is a reference point, N11, between AMF and SMF, which implies that SMF is at least partly controlled by AMF. N4 is used by SMF and UPF so that the UPF can be set using the control signal generated by the SMF, and the UPF can report its state to the SMF. N9 is the reference point for the connection between different UPFs, and N14 is the reference point connecting between different AMFs, respectively. N15 and N7 are defined since PCF applies policy to AMF and SMF, respectively. N12 is required for the AMF to perform authentication of the UE. N8 and N10 are defined because the subscription data of UE is required for AMF and SMF.

The 5G core network aims at separating user plane and control plane. The user plane carries user traffic while the control plane carries signaling in the network. In FIG. 2, the UPF is in the user plane and all other NFs, i.e., AMF, SMF, PCF, AF, AUSF, and UDM, are in the control plane. Separating the user and control planes guarantees each plane resource to be scaled independently. It also allows UPFs to be deployed separately from control plane functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF and SMF are independent functions in the control plane. Separated AMF and SMF allow independent evolution and scaling. Other control plane functions like PCF and AUSF can be separated as shown in FIG. 2. Modularized function design enables the 5G core network to support various services flexibly.

Each NF interacts with another NF directly. It is possible to use intermediate functions to route messages from one NF to another NF. In the control plane, a set of interactions between two NFs is defined as service so that its reuse is possible. This service enables support for modularity. The user plane supports interactions such as forwarding operations between different UPFs.

FIG. 3 illustrates a 5G network architecture using service-based interfaces between the NFs in the control plane, instead of the point-to-point reference points/interfaces used in the 5G network architecture of FIG. 2. However, the NFs described above with reference to FIG. 2 correspond to the NFs shown in FIG. 3. The service(s) etc. that a NF provides to other authorized NFs can be exposed to the authorized NFs through the service-based interface. In FIG. 3 the service based interfaces are indicated by the letter “N” followed by the name of the NF, e.g. Namf for the service based interface of the AMF and Nsmf for the service based interface of the SMF etc. The Network Exposure Function (NEF) and the Network Function Repository Function (NRF) in FIG. 3 are not shown in FIG. 2 discussed above. However, it should be clarified that all NFs depicted in FIG. 2 can interact with the NEF and the NRF of FIG. 3 as necessary, though not explicitly indicated in FIG. 2.

Some properties of the NFs shown in FIGS. 2-3 may be described in the following manner. The AMF provides UE-based authentication, authorization, mobility management, etc. A UE even using multiple access technologies is basically connected to a single AMF because the AMF is independent of the access technologies. The SMF is responsible for session management and allocates IP addresses to UEs. It also selects and controls the UPF for data transfer. If a UE has multiple sessions, different SMFs may be allocated to each session to manage them individually and possibly provide different functionalities per session. The AF provides information on the packet flow to PCF responsible for policy control in order to support Quality of Service (QoS). Based on the information, PCF determines policies about mobility and session management to make AMF and SMF operate properly. The AUSF supports authentication function for UEs or similar and thus stores data for authentication of UEs or similar while UDM stores subscription data of UE. The Data Network (DN), not part of the 5G core network, provides Internet access or operator services and similar.

An NF may be implemented either as a network element on a dedicated hardware, as a software instance running on a generic hardware, or as a virtualized function instantiated on an appropriate platform, e.g., a cloud infrastructure.

The Nudm_EventExposure service is used by consumer NFs (e.g. NEF) to subscribe to notifications of event occurrence by means of the Subscribe service operation. For events that can be detected by the AMF, the UDM makes use of the appropriate AMF service operation to subscribe on behalf of the consumer NF (e.g. NEF).

FIG. 4 illustrates a scenario where a UE reachability is requested and a service area restriction is deployed in the network.

The scenario shown in FIG. 4 involves a UE 401, an AMF 403 (referred to as AMF-1), an AMF 405 (referred to as AMF-2), a UDM 407, and an NEF 409. It is only an example and the real scenario is not limited thereto.

When NEF 409 initiates a UE reachability subscription for a certain user equipment, e.g., a UE reachability for SMS for UE 401, one of UDM instance such as UDM 407 is selected based on load balancing rules. UDM 407 receives the reachability subscription from NEF 409 via Nudm_EventExposure_Subscribe (S402).

Since the event is UE reachability for SMS, UDM 407 includes its own address for indirect reporting in Namf_EventExposure_Subscribe, given that the reachability for SMS is to be reported by the serving node, in this case AMF 403, to the subscribing entity, i.e., NEF 409 (S404).

If UE 401 moves and the serving node changes from AMF 403 to AMF 405, AMF 405 requests the UE context transfer. AMF 403 includes the subscription to UE reachability and the list of service areas restricted as part of the UE context, and transmits the UE context to AMF 405 (S406).

AMF 405 then transmits Nudm_UECM_registration to UDM 407 to register UE 401 to UDM 407 (S408).

UDM 407 then notifies NEF 409 of the event UE reachability for SMS via Nudm_EventExposure_Notify since UE activity has occurred (S410).

If UE 401 is in a restricted service area at the moment, i.e., in a tracking area/location where the UE is not allowed for any communication services: neither voice calls, SMS nor IP traffic (e.g. gmail), the SMS delivery will fail, which will causes wrong SMS delivery attempts and worsens the statistics of the operator, which eventually will think that radio coverage might be poor when in reality the SMS should have not been attempted in first place since the notification about UE being reachable was not correct.

if the service related entity attempts to deliver the SMS and delivery fails (due to UE in a restricted/not allowed service area), steps S402-S404 will take place again and, if UE 401 stays in the restricted service area for a long period, at every periodic registration update initiated by the UE 401, AMF 405 will notify UDM 407 about UE reachability event (UE reachable) which in turn will notify NEF 409 about the UE being reachable. The SMS delivery will repeatedly fail, and the procedure will be started from step S402 once again.

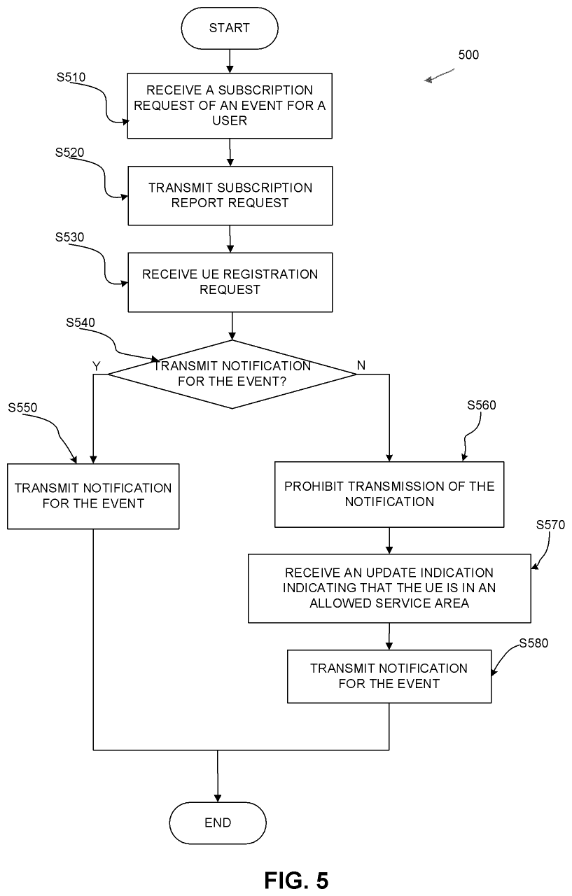

Hereinafter, a method for event subscription management in a network comprising a set of NF nodes according to an exemplary embodiment of the present disclosure will be described with reference to FIGS. 5-10.

FIG. 5 illustratively shows a flowchart of a method 500 for managing event subscription according to an exemplary embodiment of the present disclosure. In an embodiment, the method 500 may be performed at a first Network Function (NF) node. The first NF node may be, for example, a UDM.

As shown in FIG. 5, the method 500 may include steps S510-S580.

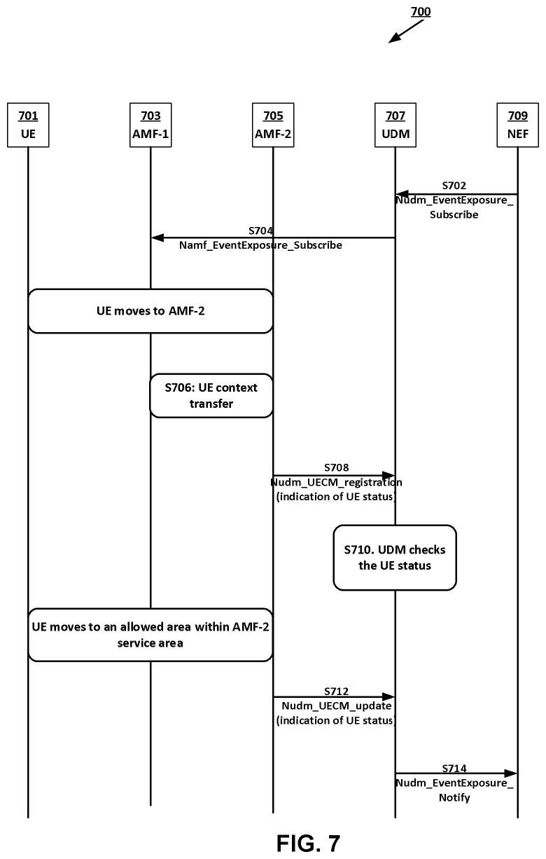

In step S510, a subscription request of an event for a UE is received from a third NF node. The subscription request of an event may be for example a UE reachability, or a UE reachability for SMS. The third NF node may be for example an NEF. An example of step S510 is step S702 in FIG. 7.

Then in step S520, a subscription report request for the event for the UE may be transmitted to a second NF node. In case that the subscription request of an event is a subscription of a UE reachability for SMS from a NEF, the second NF node may be for example an AMF which serves the UE, and the subscription report request may be for example an Namf_EventExposure_Subscribe. Since the event is UE reachability for SMS, the first NF node (e.g., UDM) includes its own address for indirect reporting in Namf_EventExposure_Subscribe, given that the reachability for SMS is to be reported by the AMF to the NEF. An example of step S520 is step S704 in FIG. 7.

In step S530, the first NF node receives a UE registration request for the UE from a fourth NF node that currently serves the UE. The UE registration request includes an indication indicating whether the UE is in a restricted service area. An example of step S530 is step S708 in FIG. 7.

In an exemplary embodiment of the present disclosure, the UE moves and the serving node changes from the previous AMF node (e.g., the second NF node) to a new AMF node (e.g., the fourth NF node), and the new AMF requests the UE context transfer. The previous AMF includes the subscription to UE reachability and the list of service areas restricted as part of the UE context, and transmits the UE context to the new AMF. The new AMF then transmits Nudm_UECM_registration to the first NF node to register with the first NF node.

In an exemplary embodiment of the present disclosure, the UE moves but the serving node does not change. The fourth NF node is the second NF node that currently serves the UE, and transmits Nudm_UECM_update to the first NF node to update the UE.

In the embodiment of the present disclosure, the Nudm_UECM_registration includes an indication indicating whether the UE is in a restricted service area. The first NF node then knows whether the UE is currently restricted from using services in the area or not, and determines whether to transmit a notification for the event to the third NF node based on the UE registration request in step S540. An example of step S540 is step S710 in FIG. 7.

In an exemplary embodiment of the present disclosure, the UE registration request indicates that the UE is in an allowed service area, and the first NF node transmits a notification for the event to the third NF node in step S550. An example of step S550 is step S714 in FIG. 7.

In an exemplary embodiment of the present disclosure, the UE registration request indicates that the UE is in a restricted service area, and the first NF node prohibits the transmission of the notification for the event to the third NF node in step S560.

In another exemplary embodiment of the present disclosure, the fourth NF node has no service area restriction information of the UE, and thus transmits the UE registration request indicating that a service area restriction is unknown for the UE. The first NF node prohibits the transmission of the notification for the event to the third NF node in step S560. An example of step S560 is step S710 in FIG. 7.

In an exemplary embodiment of the present disclosure, the UE moves again, from a restricted service area to an allowed service area within the fourth NF node served area, the first NF node receives from the fourth NF node an update indication indicating that the UE is in an allowed service area in step S570, and transmits a notification for the event to the third NF node in step S580. For example, the AMF transmits Nudm_UECM_update to the UDM to inform the UDM that the UE is now in an allowed service area. An example of steps S570 and S580 is steps S712 and S714 in FIG. 7.

In an exemplary embodiment of the present disclosure, the UE registration request indicates that the UE is in a restricted service area, and the first NF node sets a flag indicating that the UE is in a restricted service area, and processes subsequent requests related to terminating services towards the UE at least partially based on the flag. For example, when the flag is set, the UDM could consider the UE in a similar state as when the UE is purged or not registered in 5GC. During the processing of a TADS request, the UDM could reply the TADS request to HSS accordingly (e.g., “VOIP NOT supported”). As another example, based on local policy, when the network is deployed to have the same restrictions in the same service areas for other accesses (2G/3G/4G), UDM may indicate so with a new additional error condition (e.g., “VOIP NOT supported”+“UE_IN_AREA_RESTRICTED”) to avoid further terminating service attempts via other accesses. This is based on the NOTE in 3GPP TS 23.501:

“NOTE 3: When the services are restricted in 5GS due to Service Area Restriction, then it is assumed that the services will be also restricted in all RATs/Systems at the same location(s) using appropriate mechanisms available in the other RATs/Systems.”

In an exemplary embodiment of the present disclosure, when the first NF node receives from the fourth NF node an update indication indicating that the UE is in an allowed service area, the first NF node clears the flag.

In an exemplary embodiment of the present disclosure, in response to the UE registration request from the fourth NF node, the first NF node transmits an indication indicating that the first NF node supports a service area restriction status feature to the fourth NF node, and thus the fourth NF node may then report the service area restriction of the UE to the first NF node. In an exemplary embodiment of the present disclosure, there is a previous communication between the fourth NF node and the first NF node, e.g., communication for subscription of an event of another UE, the first NF node has transmitted the indication indicating that the first NF node supports a service area restriction status feature to the fourth NF node, and thus will not transmit the indication again to the fourth NF node in the embodiment.

In the embodiment of the present disclosure, the first NF node (e.g., UDM) is provided with information about whether the UE is available for services, and would not notify the NEF even if the UE activity occurs when the UE is not available for services, thereby avoiding wrong delivery attempts from the NEF which otherwise would be caused when the NEF was notified the UE's reachability. It allows UDM to prohibit terminating services at early stages, both in 5GC system and other accesses while the UE is camping in a restricted service area. This early stage detection allows to save a substantial amount of useless signalling for terminating service requests which otherwise would fail anyway. It also allows operators to quickly check and monitor in UDM those users which are currently camping in not allowed areas, instead of accessing each AMF in the network and checking the information.

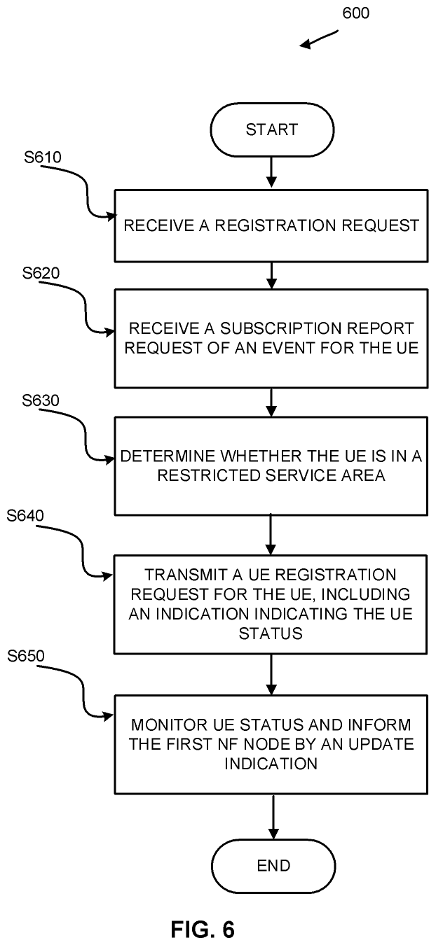

FIG. 6 illustratively shows a flowchart of a method 600 for managing event subscription according to an exemplary embodiment of the present disclosure. In an embodiment, the method 600 may be performed at a second NF node. The second NF node may be, for example, an AMF node.

As shown in FIG. 6, the method 600 may include steps S610-S650.

In step S610, the second NF node receives a registration request originated from a UE. That is, the UE registers to the second NF node. The second NF node now serves the UE.

The second NF node may receive a subscription report request of an event for the UE from a first NF node in step S620. In case that the event for the UE is a UE reachability for SMS, the first NF node may be, for example, a UDM, and the subscription report request may be for example a Namf_EventExposure_Subscribe. Since the event is UE reachability for SMS, UDM includes its own address for indirect reporting in Namf_EventExposure_Subscribe. An example of step S620 is step S704 in FIG. 7.

The second NF node then determines whether the UE is in a restricted service area in step S630, and transmits to the first NF node, a UE registration request or a UE update request for the UE, including an indication indicating whether the UE is in a restricted service area in step S640. The UE registration request may be for example Nudm_UECM_registration. The UE update request may be for example Nudm_UECM_update. An example of steps S630 and S640 is steps S706 and S708 in FIG. 7.

In the present disclosure, the AMF that serves a UE should report the status of the UE, i.e., whether the UE is in an allowed service are or a restricted service area, to a NF node which subscribes an event of the UE, for example a UDM which subscribes a UE reachability for SMS, and the NF node can use the received UE status in processing requests related to terminating services towards the UE.

In an exemplary embodiment of the present disclosure, the second NF node determines whether the UE moves from an allowed service area to a restricted service area, and transmits an update indication to the first NF node indicating that the UE is in the restricted service area when it is determined that the UE moves from the allowed service area to the restricted service area in step S650. The second NF node also determines whether the UE moves from a restricted service area to an allowed service area, and transmits an update indication to the first NF node indicating that the UE is in the allowed service area when it is determined that the UE moves from the restricted service area to the allowed service area in step S650. An example of step S650 is step S712 in FIG. 7. In the embodiment of the present disclosure, the second NF node constantly monitors the status of the UE, i.e., whether the UE is in an allowed service area or a restricted service area.

When the status of the UE changes, i.e., the UE changes from an allowed service area to a restricted service area and vice versa, the second NF node reports the change of the UE status to the first NF node, and the NF node can use the received UE status in processing requests related to terminating services towards the UE. The update indication may be for example Nudm_UECM_update.

In an exemplary embodiment of the present disclosure, the second NF node may receive from the first NF node an indication indicating that the first NF node supports a service area restriction status feature in the UE registration process, and the second NF node performs the reporting of the UE status to the first NF node in response. The transmission of the indication indicating that the first NF node supports a service area restriction status feature may not be transmitted in response to the UE registration process. In an embodiment, there is a previous communication between the second NF node and the first NF node, e.g., communication for subscription of an event of another UE, the first NF node has transmitted the indication indicating that the first NF node supports a service area restriction status feature to the second NF node, and thus will not transmit the indication again to the second NF node in the embodiment.

FIG. 7 shows an exemplifying signaling diagram 700 illustrating details of the methods schematically illustrated in FIGS. 5 and 6.

The example shown in FIG. 7 involves a UE 701, an AMF-1 703, an AMF-2 705, a UDM 707 and an NEF 709. It is only an example and the present disclosure is not limited thereto.

When a service-related entity, for example NEF 709, requests UDM 707 to provide an indication regarding UE reachability for SMS, it transmits Nudm_EventExposure_Subscribe to UDM 707 in step S702.

Since the event is UE reachability for SMS, UDM 707 includes its own address for indirect reporting in Namf_EventExposure_Subscribe, and transmits it to AMF-1 703 which currently serves UE 701 in step S704, given that the reachability for SMS is to be reported by AMF-1 703 to NEF 709.

During UE intra-5GC mobility from AMF-1 703 to AMF-2 705, AMF-2 705 receives the exposure events and service area restriction information applicable to UE 701 as part of the UE context in step S706. Then AMF-2 705 sends a UECM registration message, i.e., Nudm_UECM_registration, to UDM 707 in step S708. Before sending the Nudm_UECM_registration, AMF-2 705 which current serves UE 701 will first check if the UE entered a restricted service area (i.e. a tracking area restricted). If the UE is camping on a TAI restricted for services, AMF-2 705 will include a new indication in UECM registration, as part of the UE context management information, to inform UDM 707 that UE 701 has all services other than mobility restricted. In this case, AMF-2 705 does not remove any active exposure event for UE reachability (since the event is still to be reported).

When receiving the registration from AMF-2 705, if it is successful, UDM 707 will check if the flag “UE is in area not allowed” is set in step S710. If set, UDM will not check whether there is a service-related entity/NF to be notified. Hence, no notification about UE being reachable will be sent (yet).

When AMF-2 705 detects that UE 701 moves from a restricted service area to an allowed service area/TAI, AMF-2 705 notifies UDM 707 about UE 701 being reachable accordingly. For that, AMF-2 705 updates the registration in UDM (UE in allowed service area) via a Nudm_UECM_Update service operation in step S712. When UDM receives a UECM registration update, it checks whether UE 701 was in a restricted service area and now is in an allowed service area. If so, it retrieves the address of the service-related entity (i.e., NEF 709) and notifies NEF 709 about UE being reachable via Nudm_EventExposure_Notify in step S714. In this case, AMF-2 705 removes any exposure event for UE reachability (since it is considered now to be reported).

Alternatively, this could also be done based on the presence of the exposure event still configured in the AMF since the intra-5GC mobility procedure using existing procedures. This is, in this case AMF-2 705 sends a Namf_EventExposure_Notify service operation to UDM 707 which also triggers UDM 707 to send the corresponding Nudm_EventExposure_Notify to NEF 709 that previously subscribed to the UE reachability event.

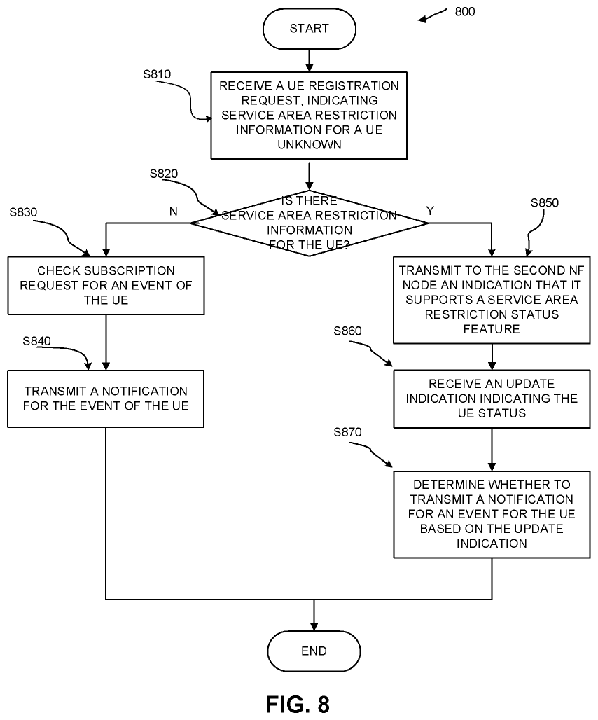

FIG. 8 illustratively shows a flowchart of a method 800 for managing event subscription according to an exemplary embodiment of the present disclosure. In an embodiment, the method 800 may be performed at a first NF node. The first NF node may be for example a UDM.

As shown in FIG. 8, the method 800 may include steps S810-S870.

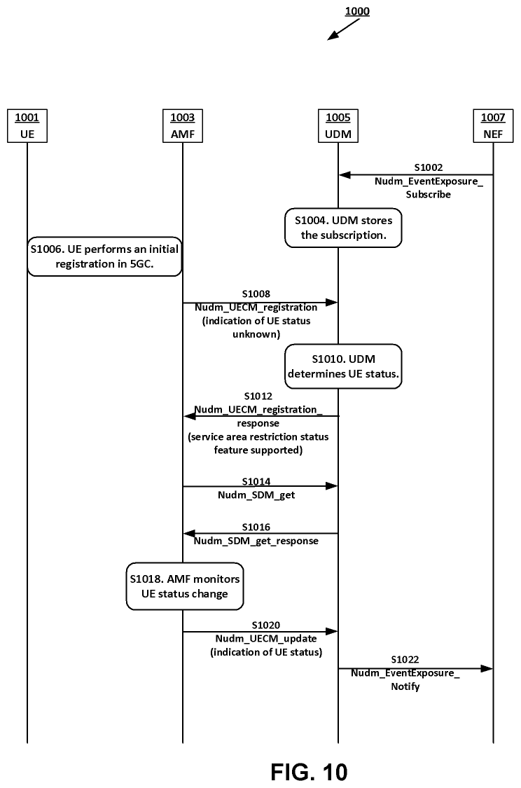

In step S810, the first NF node receives from a second NF node that serves a UE, a UE registration request including an indication indicating that service area restriction information for the UE is unknown. The second NF node may be for example an AMF. The indication indicates that the UE performs an initial registration in 5GC, and registers to the AMF. The AMF has no service area restriction information for the UE and thus cannot determine whether the UE is in a restricted or allowed service area. The UE registration request may be for example Nudm_UECM_registration from the AMF to the UDM. An example of step S810 is step S1008 in FIG. 10.

In step S820, the first NF node then checks whether there is service area restriction information for the UE.

In an exemplary embodiment of the present disclosure, in response to there is no service area restriction information for the UE, the first NF node checks whether there is a subscription request of an event for the UE from a third NF node in step S830, and transmitting a notification for the event to the third NF node in step S840. That is, if there is no service area restriction information defined for the UE, the UDM will notify about UE reachability to the service-related entity/NF, given that no service area restriction information is understood as “all areas are allowed for the UE”. An example of steps S820˜840 is step S1010 in FIG. 10.

In an exemplary embodiment of the present disclosure, in response to there is service area restriction information for the UE, the first NF node transmits to the second NF node an indication indicating that the first NF node supports a service area restriction status feature in step S850. The first NF node also transmits the service area restriction information for the UE to the second NF node, which now can determine whether the UE is in a restricted or allowed service area. The transmission of the indication indicating that the first NF node supports a service area restriction status feature may not be transmitted in response to the UE registration process. In an embodiment, there is a previous communication between the second NF node and the first NF node, e.g., communication for subscription of an event of another UE, the first NF node has transmitted the indication indicating that the first NF node supports a service area restriction status feature to the second NF node, and thus will not transmit the indication again to the second NF node in the embodiment. An example of step S850 is step S1012 in FIG. 10.

Then the first NF node receives from the second NF node an update indication indicating whether the UE is in a restricted service area in step S860, and determines whether to transmit a notification for an event for the UE to a third NF node based on the update indication in step S870. When the update indication indicates that the UE is in an allowed service area, the first NF node transmits a notification for the event to the third NF node. When the update indication indicates that the UE is in a restricted service area, the first NF node prohibits the transmission of the notification for the event to the third NF node. When the UE moves from the restricted service area to an allowed service area, the first NF node receives, from the second NF node, an update indication indicating that the UE is in an allowed service area and transmits a notification for the event to the third NF node. The update indication may be for example Nudm_UECM_update from the AMF to the UDM. An example of steps S860 and S870 is steps S1020 and S1022 in FIG. 10.

In an exemplary embodiment of the present disclosure, the update indication indicates that the UE is in a restricted service area, and the first NF node sets a flag indicating that the UE is in a restricted service area, and processes subsequent requests related to terminating services towards the UE at least partially based on the flag. For example, when the flag is set, the UDM could consider the UE in a similar state as when the UE is purged or not registered in 5GC. During the processing of a TADS request, the UDM could reply the TADS request to HSS accordingly (e.g., “VOIP NOT supported”). As another example, based on local policy, when the network is deployed to have the same restrictions in the same service areas for other accesses (2G/3G/4G), UDM may indicate so with a new additional error condition (e.g., “VOIP NOT supported”+“UE_IN_AREA_RESTRICTED”) to avoid further terminating service attempts via other accesses. This is based on the NOTE in 3GPP TS 23.501:

“NOTE 3: When the services are restricted in 5GS due to Service Area Restriction, then it is assumed that the services will be also restricted in all RATs/Systems at the same location(s) using appropriate mechanisms available in the other RATs/Systems.”

In an exemplary embodiment of the present disclosure, when the first NF node receives from the second NF node an update indication indicating that the UE is in an allowed service area, the first NF node clears the flag.

In the embodiment of the present disclosure, the first NF node (e.g., UDM) is provided with information about whether the UE is available for services. When the second NF node (e.g., AMF) cannot determine whether the UE is available for services due to lacking service area restriction information for the UE, it provides the UDM with an indication indicating that the service area restriction information for the UE is known, and monitors the UE status after receiving the service area restriction information and notifies the UDM of the UE status. The UDM would not notify the NEF even if the UE activity occurs when the UE is not available for services, thereby avoiding wrong delivery attempts from the NEF which otherwise would be caused when the NEF was notified the UE's reachability. It allows UDM to prohibit terminating services at early stages, both in 5GC system and other accesses while the UE is camping in a restricted service area. This early stage detection allows to save a substantial amount of useless signalling for terminating service requests which otherwise would fail anyway. It also allows operators to quickly check and monitor in UDM those users which are currently camping in not allowed areas, instead of accessing each AMF in the network and checking the information.

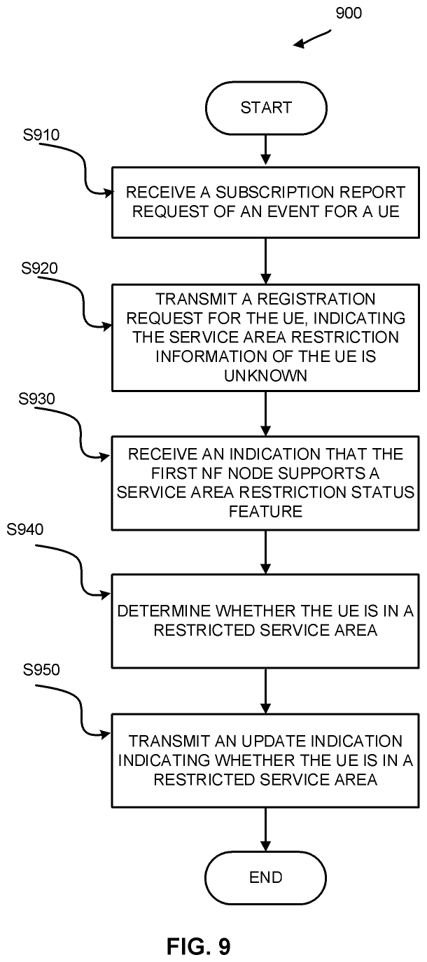

FIG. 9 illustratively shows a flowchart of a method 900 for managing event subscription according to an exemplary embodiment of the present disclosure. In an embodiment, the method 900 may be performed at a second NF node. The second NF node may be, for example, an AMF node.

As shown in FIG. 9, the method 900 may include Steps S910-S950.

In step S910, the second NF node receives from a first NF node a subscription report request of an event for a UE. The first NF node may be for example a UDM, and the event may be a UE reachability event, e.g., a reachability for SMS.

In step S920, the second NF node transmits to the first NF node a UE registration request for the UE, the UE registration request including an indication indicating that service area restriction information for the UE is unknown. The indication indicates that the UE performs an initial registration in 5GC, and registers to the AMF. The AMF has no service area restriction information for the UE and thus cannot determine whether the UE is in a restricted or allowed service area. The UE registration request may be for example Nudm_UECM_registration from the AMF to the UDM. An example of step S920 is step S1008 in FIG. 10.

In an exemplary embodiment of the present disclosure, the second NF node receives from the first NF node an indication indicating that the first NF node supports a service area restriction status feature and service area restriction information for the UE in step S930, determines whether the UE is in a restricted service area based on the service area restriction information in step S940, and transmits to the first NF node an update indication indicating whether the UE is in a restricted service area in step S950. An example of steps S930, S940, and S950 is step S1012, S1018 and S1020 in FIG. 10.

In an exemplary embodiment of the present disclosure, the second NF node determines whether the UE moves from an allowed service area to a restricted service area, and transmits an update indication to the first NF node indicating that the UE is in the restricted service area when it is determined that the UE moves from the allowed service area to the restricted service area. The second NF node also determines whether the UE moves from a restricted service area to an allowed service area, and transmits an update indication to the first NF node indicating that the UE is in the allowed service area when it is determined that the UE moves from the restricted service area to the allowed service area. In the embodiment of the present disclosure, the second NF node constantly monitors the status of the UE, i.e., whether the UE is in an allowed service area or a restricted service area. When the status of the UE changes, i.e., the UE changes from an allowed service area to a restricted service area and vice versa, the second NF node reports the change of the UE status to the first NF node, and the NF node can use the received UE status in processing requests related to terminating services towards the UE. The update indication may be for example Nudm_UECM_update.

In an exemplary embodiment of the present disclosure, the second NF node performs the reporting of the UE status to the first NF node in response to a determination that the first NF node supports the service area restriction status feature. The transmission of the indication indicating that the first NF node supports a service area restriction status feature may not be transmitted in response to the UE registration process. In an embodiment, there is a previous communication between the second NF node and the first NF node, e.g., communication for subscription of an event of another UE, the first NF node has transmitted the indication indicating that the first NF node supports a service area restriction status feature to the second NF node, and thus will not transmit the indication again to the second NF node in the embodiment.

FIG. 10 shows an exemplifying signaling diagram 1000 illustrating details of the methods schematically illustrated in FIGS. 8 and 9.

The example shown in FIG. 10 involves a UE 1001, an AMF 1003, a UDM 1005, and an NEF 1007. It is only an example and the present disclosure is not limited thereto.

When a service-related entity, for example NEF 1007, requests UDM 1005 to provide an indication regarding UE reachability for SMS, it transmits Nudm_EventExposure_Subscribe to UDM 1005 in step S1002.

In this case, since UE 1001 is not registered in 5GC yet, UDM 1005 stores the subscription in step S1004.

UE 1001 performs an initial registration in 5GC in step S1006. In this case, AMF 1003 does not have any information about service area restriction for the UE yet, so AMF 1003 sends a UECM registration request Nudm_UECM_registration to UDM 1005 including an indication that “service area restriction is unknown” in step S1008.

When receiving the registration from AMF 1003, if it is successful, UDM 1005 will check if the “service area restriction unknown” flag is set in step S1010. If set, UDM 1005 will also check if UE1001 has service area restriction information within the Access and Mobility subscription data. If so, UDM 1005 will not check whether there is a service-related entity/NF to be notified. Hence, no notification about UE being reachable will be sent (yet). If there is no service area restriction information defined for UE 1001, then UDM 1005 will notify about UE reachability to NEF 1007, given that no service area restriction information is understood as “all areas are allowed for the UE”.

UDM 1005 transmits a UECM registration request response Nudm_UECM_registration_response to AMF 1003 in step S1012, including an indication indicating that UDM 1005 supports a service area restriction status feature. In another example, if there was a previous communication between the AMF 1003 and UDM 1005, e.g., communication for subscription of an event of another UE, and UDM 1005 had transmitted the indication indicating that UDM 1005 supports a service area restriction status feature to AMF 1003, and UDM 1005 will not transmit the indication again to AMD 1003 in the embodiment.

During the initial registration procedure, AMF 1003 retrieves subscription data from UDM 1005 in step S1014-S1016. If service restriction information is defined for UE 1001, UDM 1005 provides it to AMF 1003 in step S1016 as part of the subscription data.

AMF 1003 checks the service area restriction information (if present) and monitors the UE status change in step S1018. AMF 1003 informs UDM 1005 about whether the UE is camping in a restricted TAI or not via an Nudm_UECM_Update service operation in step S1020. AMF 1003 sends this update based on the indication from UDM 1005 that it supports the feature “service area restriction status in UE context” as received in step S1012 or received in a previous communication.

Based on the service area restriction status included in the Nudm_UECM_Update service operation, UDM 1005 decides whether to notify about UE reachability to NEF 1007. This is, if AMF 1003 indicates that the UE is in an allowed area then UDM 1005 sends the notification via Nudm_EventExposure_Notify in step S1022. Otherwise UDM 1005 will keep the NEF subscription until the AMF (or another AMF) reports that the UE is reachable in an allowed service area.

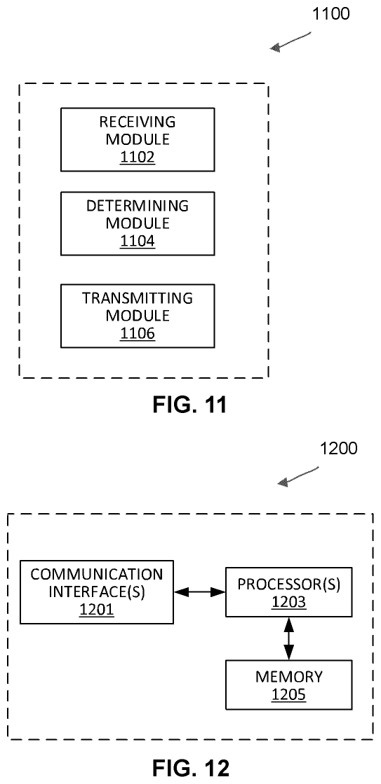

Hereinafter, a structure of a first NF node will be described with reference to FIG. 11. FIG. 11 illustratively shows a schematic structure diagram of a first NF node 1100 (e.g. UDM 707 as shown in FIG. 7 and/or UDM 1005 as shown in FIG. 10, as described previously) according to an exemplary embodiment of the present disclosure. The first NF node 1100 in FIG. 11 may perform the method 500 for event subscription management described previously with reference to FIG. 5 and/or the method 800 for event subscription management described previously with reference to FIG. 8. Accordingly, some detailed description on the first NF node 1100 may refer to the corresponding description of the method 500 for event subscription management and/or the corresponding description of the method 800 for event subscription management as previously discussed.

As shown in FIG. 11, the first NF node 1100 may include a receiving module 1102, a determining module 1104, and a transmitting module 1106. As will be understood by the skilled in the art, common components in the first NF node 1100 are omitted in FIG. 11 for not obscuring the idea of the present disclosure. Also, some modules may be distributed in more modules or integrated into fewer modules. For example, the receiving module 1102 and the transmitting module 1106 may be integrated into a transceiver module.

In an exemplary embodiment of the present disclosure, the receiving module 1102 of the first NF node 1100 may be configured to receive a subscription request of an event for a UE from a third NF node. The subscription request of an event may be for example a UE reachability, or a UE reachability for SMS. The third NF node may be for example a NEF.

In an exemplary embodiment of the present disclosure, the transmitting module 1106 of the first NF node 1100 may be configured to transmit a subscription report request for the event for the UE to a second NF node. In case that the subscription request of an event is a subscription of a UE reachability for SMS from an NEF, the second NF node may be for example an AMF which serves the UE, and the subscription report request may be for example an Namf_EventExposure_Subscribe. Since the event is UE reachability for SMS, the first NF node (e.g., UDM) includes its own address for indirect reporting in Namf_EventExposure_Subscribe, given that the reachability for SMS is to be reported by the AMF to the NEF.

In an exemplary embodiment of the present disclosure, the receiving module 1102 of the first NF node 1100 may be configured to receive a UE registration request for the UE from a fourth NF node that currently serves the UE. The UE registration request includes an indication indicating whether the UE is in a restricted service area.

In an exemplary embodiment of the present disclosure, the determining module 1104 of the first NF node 1100 may be configured to determine whether to transmit a notification for the event to the third NF node based on the UE registration request.

In an exemplary embodiment of the present disclosure, the UE registration request indicates that the UE is in an allowed service area, and the transmitting module 1106 of the first NF node 1100 may be configured to transmit a notification for the event to the third NF node.

In an exemplary embodiment of the present disclosure, the transmitting module 1106 of the first NF node 1100 may be configured to transmit the UE registration request indicating that a service area restriction is unknown for the UE.

In an exemplary embodiment of the present disclosure, the receiving module 1102 of the first NF node 1100 may be configured to receive an update indication indicating that the UE is in an allowed service area, and the transmitting module 1106 of the first NF node 1100 may be configured to transmit a notification for the event to the third NF node.

In an exemplary embodiment of the present disclosure, the transmitting module 1106 of the first NF node 1100 may be configured to transmit an indication indicating that the first NF node supports a service area restriction status feature.

In an exemplary embodiment of the present disclosure, the receiving module 1102 of the first NF node 1100 may be configured to receive from a second NF node that serves a UE, a UE registration request including an indication indicating that service area restriction information for the UE is unknown.

In an exemplary embodiment of the present disclosure, the determining module 1104 of the first NF node 1100 may be configured to check whether there is service area restriction information for the UE.

In an exemplary embodiment of the present disclosure, in response to there is no service area restriction information for the UE, the determining module 1104 of the first NF node 1100 may be configured to check whether there is a subscription request of an event for the UE from a third NF node, and the transmitting module 1106 of the first NF node 1100 may be configured to transmit a notification for the event to the third NF node.

In an exemplary embodiment of the present disclosure, in response to there is service area restriction information for the UE, the transmitting module 1106 of the first NF node 1100 may be configured to transmit to the second NF node an indication indicating that the first NF node supports a service area restriction status feature. The transmitting module 1106 of the first NF node 1100 may be further configured to transmit the service area restriction information for the UE to the second NF node, which now can determine whether the UE is in a restricted or allowed service area.

In an exemplary embodiment of the present disclosure, the receiving module 1102 of the first NF node 1100 may be configured to receive from the second NF node an update indication indicating whether the UE is in a restricted service area, and the determining module 1104 of the first NF node 1100 may be configured to determine whether to transmit a notification for an event for the UE to a third NF node based on the update indication. When the update indication indicates that the UE is in an allowed service area, the transmitting module 1106 of the first NF node 1100 may be configured to transmit a notification for the event to the third NF node.

When the UE moves from the restricted service area to an allowed service area, the receiving module 1102 of the first NF node 1100 may be configured to receive, from the second NF node, an update indication indicating that the UE is in an allowed service area, and the transmitting module 1106 of the first NF node 1100 may be configured to transmit a notification for the event to the third NF node. The update indication may be for example Nudm_UECM_update from the AMF to the UDM.

Hereinafter, another structure of a first NF node 1200 will be described with reference to FIG. 12. FIG. 12 illustratively shows a schematic structure diagram of a first NF node 1200 (e.g., UDM 707 as shown in FIG. 7 and/or UDM 1005 as shown in FIG. 10, as described previously) according to an exemplary embodiment of the present disclosure. The first NF node 1200 in FIG. 12 may perform the method 500 for event subscription management described previously with reference to FIG. 5 and/or the method 800 for event subscription management described previously with reference to FIG. 8. Accordingly, some detailed description on the first NF node 1200 may refer to the corresponding description of the method 500 for event subscription management and/or the corresponding description of the method 800 for event subscription management as previously discussed.

As shown in FIG. 12, the first NF node 1200 may include at least one controller or processor 1203 including e.g., any suitable Central Processing Unit, CPU, microcontroller, Digital Signal Processor, DSP, etc., capable of executing computer program instructions. The computer program instructions may be stored in a memory 1205. The memory 1205 may be any combination of a RAM (Random Access Memory) and a ROM (Read Only Memory). The memory may also comprise persistent storage, which, for example, can be any single one or combination of magnetic memory, optical memory, or solid state memory or even remotely mounted memory. The exemplary first NF node 1200 further comprises a communication interface 1201 arranged for communication.

The instructions, when loaded from the memory 1205 and executed by the at least one processor 1203, may cause the first NF node 1200 to perform the method 500 for event subscription management and/or the method 800 for event subscription management as previously discussed.

In particular, in an exemplary embodiment of the present disclosure, the instructions, when loaded from the memory 1205 and executed by the at least one processor 1203, may cause the first NF node 1200 to receive a subscription request of an event for a UE from a third NF node. The subscription request of an event may be for example a UE reachability or a UE reachability for SMS. The third NF node may be for example a NEF.

In an exemplary embodiment of the present disclosure, the instructions, when loaded from the memory 1205 and executed by the at least one processor 1203, may cause the first NF node 1200 to transmit a subscription report request for the event for the UE to a second NF node. In case that the subscription request of an event is a subscription of a UE reachability for SMS from a NEF, the second NF node may be for example an AMF which serves the UE, and the subscription report request may be for example a Namf_EventExposure_Subscribe. Since the event is UE reachability for SMS, the first NF node (e.g., UDM) includes its own address for indirect reporting in Namf_EventExposure_Subscribe, given that the reachability for SMS is to be reported by the AMF to the NEF.

In an exemplary embodiment of the present disclosure, the instructions, when loaded from the memory 1205 and executed by the at least one processor 1203, may cause the first NF node 1200 to receive a UE registration request for the UE from a fourth NF node that currently serves the UE. The UE registration request includes an indication indicating whether the UE is in a restricted service area.

In an exemplary embodiment of the present disclosure, the instructions, when loaded from the memory 1205 and executed by the at least one processor 1203, may cause the first NF node 1200 to determine whether to transmit a notification for the event to the third NF node based on the UE registration request.

In an exemplary embodiment of the present disclosure, the UE registration request indicates that the UE is in an allowed service area, and the instructions, when loaded from the memory 1205 and executed by the at least one processor 1203, may cause the first NF node 1200 to transmit a notification for the event to the third NF node.

In an exemplary embodiment of the present disclosure, the instructions, when loaded from the memory 1205 and executed by the at least one processor 1203, may cause the first NF node 1200 to transmit the UE registration request indicating that a service area restriction is unknown for the UE.

In an exemplary embodiment of the present disclosure, the instructions, when loaded from the memory 1205 and executed by the at least one processor 1203, may cause the first NF node 1200 to receive an update indication indicating that the UE is in an allowed service area, and to transmit a notification for the event to the third NF node.

In an exemplary embodiment of the present disclosure, the instructions, when loaded from the memory 1205 and executed by the at least one processor 1203, may cause the first NF node 1200 to transmit an indication indicating that the first NF node supports a service area restriction status feature.

In an exemplary embodiment of the present disclosure, the instructions, when loaded from the memory 1205 and executed by the at least one processor 1203, may cause the first NF node 1200 to receive from a second NF node that serves a UE, a UE registration request including an indication indicating that service area restriction information for the UE is unknown.

In an exemplary embodiment of the present disclosure, the instructions, when loaded from the memory 1205 and executed by the at least one processor 1203, may cause the first NF node 1200 to check whether there is service area restriction information for the UE.

In an exemplary embodiment of the present disclosure, in response to there is no service area restriction information for the UE, the instructions, when loaded from the memory 1205 and executed by the at least one processor 1203, may cause the first NF node 1200 to check whether there is a subscription request of an event for the UE from a third NF node, and to transmit a notification for the event to the third NF node.

In an exemplary embodiment of the present disclosure, in response to there is service area restriction information for the UE, the instructions, when loaded from the memory 1205 and executed by the at least one processor 1203, may cause the first NF node 1200 to transmit to the second NF node an indication indicating that the first NF node supports a service area restriction status feature, and to transmit the service area restriction information for the UE to the second NF node, which now can determine whether the UE is in a restricted or allowed service area.

In an exemplary embodiment of the present disclosure, the instructions, when loaded from the memory 1205 and executed by the at least one processor 1203, may cause the first NF node 1200 to receive from the second NF node an update indication indicating whether the UE is in a restricted service area, and to determine whether to transmit a notification for an event for the UE to a third NF node based on the update indication. When the update indication indicates that the UE is in an allowed service area, the instructions, when loaded from the memory 1205 and executed by the at least one processor 1203, may cause the first NF node 1200 to transmit a notification for the event to the third NF node.

When the UE moves from the restricted service area to an allowed service area, the instructions, when loaded from the memory 1205 and executed by the at least one processor 1203, may cause the first NF node 1200 to receive, from the second NF node, an update indication indicating that the UE is in an allowed service area, and to transmit a notification for the event to the third NF node. The update indication may be for example Nudm_UECM_update from the AMF to the UDM.

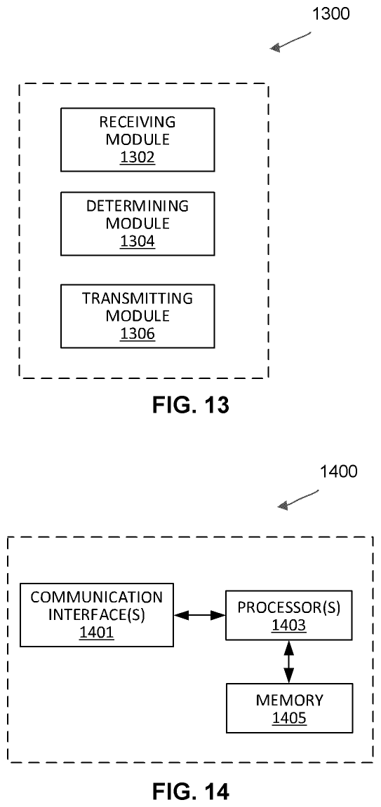

Hereinafter, a structure of a second NF node will be described with reference to FIG. 13. FIG. 13 illustratively shows a schematic structure diagram of a second NF node 1300 (e.g. AMF-1 703 and AMF-2 705 as shown in FIG. 7 and AMF 1003 as shown in FIG. 10, as described previously) according to an exemplary embodiment of the present disclosure. The second NF node 1300 in FIG. 13 may perform the method 600 for event subscription management described previously with reference to FIG. 6 and/or the method 900 for event subscription management described previously with reference to FIG. 9. Accordingly, some detailed description on the second NF node 1300 may refer to the corresponding description of the method 600 for event subscription management and/or the corresponding description of the method 900 for event subscription management as previously discussed.

As shown in FIG. 13, the second NF node 1300 may include a receiving module 1302, a determining module 1304, and a transmitting module 1306. As will be understood by the skilled in the art, common components in the second NF node 1300 are omitted in FIG. 13 for not obscuring the idea of the present disclosure. Also, some modules may be distributed in more modules or integrated into fewer modules. For example, the receiving module 1302 and the transmitting module 1306 may be integrated into a transceiver module.

In an exemplary embodiment of the present disclosure, the receiving module 1302 of the second NF node 1300 may be configured to receive a registration request originated from a UE. That is, the UE registers to the second NF node. The second NF node now serves the UE.

In an exemplary embodiment of the present disclosure, the receiving module 1302 of the second NF node 1300 may be configured to receive a subscription report request of an event for the UE from a first NF node. In case that the event for the UE is a UE reachability for SMS, the first NF node may be, for example, a UDM, and the subscription report request may be for example a Namf_EventExposure_Subscribe. Since the event is UE reachability for SMS, UDM includes its own address for indirect reporting in Namf_EventExposure_Subscribe.

In an exemplary embodiment of the present disclosure, the determining module 1304 of the second NF node 1300 may be configured to determine whether the UE is in a restricted service area, and the transmitting module 1306 of the second NF node 1300 may be configured to transmit to the first NF node, a UE registration request for the UE, including an indication indicating whether the UE is in a restricted service area. The UE registration request may be for example Nudm_UECM_registration.

In an exemplary embodiment of the present disclosure, the determining module 1304 of the second NF node 1300 may be configured to determine whether the UE moves from an allowed service area to a restricted service area, and the transmitting module 1306 of the second NF node 1300 may be configured to transmit an update indication to the first NF node indicating that the UE is in the restricted service area when it is determined that the UE moves from the allowed service area to the restricted service area. In an exemplary embodiment of the present disclosure, the determining module 1304 of the second NF node 1300 may be configured to determine whether the UE moves from a restricted service area to an allowed service area, and the transmitting module 1306 of the second NF node 1300 may be configured to transmit an update indication to the first NF node indicating that the UE is in the allowed service area when it is determined that the UE moves from the restricted service area to the allowed service area. In the embodiment of the present disclosure, the second NF node 1300 constantly monitors the status of the UE, i.e., whether the UE is in an allowed service area or a restricted service area. When the status of the UE changes, i.e., the UE changes from an allowed service area to a restricted service area and vice versa, the second NF node 1300 reports the change of the UE status to the first NF node, and the NF node can use the received UE status in processing requests related to terminating services towards the UE. The update indication may be for example Nudm_UECM_update.

In an exemplary embodiment of the present disclosure, the receiving module 1302 of the second NF node 1300 may be configured to receive from the first NF node an indication indicating that the first NF node supports a service area restriction status feature in the UE registration process, and the second NF node 1300 performs the reporting of the UE status to the first NF node in response.

Hereinafter, another structure of a second NF node will be described with reference to FIG. 14. FIG. 14 illustratively shows a schematic structure diagram of a second NF node 1400 (e.g., AMF-1 703 and AMF-2 705 as shown in FIG. 7 and AMF 1003 as shown in FIG. 10, as described previously) according to an exemplary embodiment of the present disclosure. The second NF node 1400 in FIG. 14 may perform the method 600 for event subscription management described previously with reference to FIG. 6 and/or the method 900 for event subscription management described previously with reference to FIG. 9. Accordingly, some detailed description on the second NF node 1400 may refer to the corresponding description of the method 600 for event subscription management and/or the corresponding description of the method 900 for event subscription management as previously discussed.

As shown in FIG. 14, the second NF node 1400 may include at least one controller or processor 1403 including e.g., any suitable Central Processing Unit, CPU, microcontroller, Digital Signal Processor, DSP, etc., capable of executing computer program instructions. The computer program instructions may be stored in a memory 1405. The memory 1405 may be any combination of a RAM (Random Access Memory) and a ROM (Read Only Memory). The memory may also comprise persistent storage, which, for example, can be any single one or combination of magnetic memory, optical memory, or solid state memory or even remotely mounted memory. The exemplary second NF node 1400 further comprises a communication interface 1401 arranged for communication.

The instructions, when loaded from the memory 1405 and executed by the at least one processor 1403, may cause the second NF node 1400 to perform the method 600 for event subscription management described previously with reference to FIG. 6 and/or the method 900 for event subscription management described previously with reference to FIG. 9.

In particular, in an exemplary embodiment of the present disclosure, the instructions, when loaded from the memory 1405 and executed by the at least one processor 1403, may cause the second NF node 1400 to receive a registration request originated from a UE. That is, the UE registers to the second NF node. The second NF node now serves the UE.

In an exemplary embodiment of the present disclosure, the instructions, when loaded from the memory 1405 and executed by the at least one processor 1403, may cause the second NF node 1400 to receive a subscription report request of an event for the UE from a first NF node. In case that the event for the UE is a UE reachability for SMS, the first NF node may be, for example, a UDM, and the subscription report request may be for example a Namf_EventExposure_Subscribe. Since the event is UE reachability for SMS, UDM includes its own address for indirect reporting in Namf_EventExposure_Subscribe.

In an exemplary embodiment of the present disclosure, the instructions, when loaded from the memory 1405 and executed by the at least one processor 1403, may cause the second NF node 1400 to determine whether the UE is in a restricted service area, and to transmit to the first NF node, a UE registration request for the UE, including an indication indicating whether the UE is in a restricted service area. The UE registration request may be for example Nudm_UECM_registration.

In an exemplary embodiment of the present disclosure, the instructions, when loaded from the memory 1405 and executed by the at least one processor 1403, may cause the second NF node 1400 to determine whether the UE moves from an allowed service area to a restricted service area, and to transmit an update indication to the first NF node indicating that the UE is in the restricted service area when it is determined that the UE moves from the allowed service area to the restricted service area. In an exemplary embodiment of the present disclosure, the instructions, when loaded from the memory 1405 and executed by the at least one processor 1403, may cause the second NF node 1400 to determine whether the UE moves from a restricted service area to an allowed service area, and to transmit an update indication to the first NF node indicating that the UE is in the allowed service area when it is determined that the UE moves from the restricted service area to the allowed service area. In the embodiment of the present disclosure, the second NF node 1400 constantly monitors the status of the UE, i.e., whether the UE is in an allowed service area or a restricted service area. When the status of the UE changes, i.e., the UE changes from an allowed service area to a restricted service area and vice versa, the second NF node 1400 reports the change of the UE status to the first NF node, and the NF node can use the received UE status in processing requests related to terminating services towards the UE. The update indication may be for example Nudm_UECM_update.

In an exemplary embodiment of the present disclosure, the instructions, when loaded from the memory 1405 and executed by the at least one processor 1403, may cause the second NF node 1400 to receive from the first NF node an indication indicating that the first NF node supports a service area restriction status feature in the UE registration process, and the second NF node 1400 performs the reporting of the UE status to the first NF node in response.

The foregoing description of implementations provides illustration and description, but is not intended to be exhaustive or to limit the disclosure to the precise form disclosed. Modifications and variations are possible in light of the above teachings, or may be acquired from practice of the disclosure.

Aspects of the disclosure may also be embodied as methods and/or computer program products. Accordingly, the disclosure may be embodied in hardware and/or in hardware/software (including firmware, resident software, microcode, etc.). Furthermore, the embodiments may take the form of a computer program product on a computer-usable or computer-readable storage medium having computer-usable or computer-readable program code embodied in the medium for use by or in connection with an instruction execution system. Such instruction execution system may be implemented in a standalone or distributed manner. The actual software code or specialized control hardware used to implement embodiments described herein is not limiting of the disclosure. Thus, the operation and behavior of the aspects were described without reference to the specific software code, it being understood that those skilled in the art will be able to design software and control hardware to implement the aspects based on the description herein.

Furthermore, certain portions of the disclosure may be implemented as “logic” that performs one or more functions. This logic may include hardware, such as an application specific integrated circuit or field programmable gate array or a combination of hardware and software.

It should be emphasized that the term “comprises/comprising” when used in this specification is taken to specify the presence of stated features, integers, steps, components or groups but does not preclude the presence or addition of one or more other features, integers, steps, components or groups thereof.

No element, act, or instruction used in the disclosure should be construed as critical or essential to the disclosure unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

The foregoing description gives only the embodiments of the present disclosure and is not intended to limit the present disclosure in any way. Thus, any modification, substitution, improvement or like made within the spirit and principle of the present disclosure should be encompassed by the scope of the present disclosure.

1-46. (canceled)

47. A method implemented at a first Network Function (NF) node for managing event subscription, the method comprising:
receiving a subscription request of an event for a user equipment (UE) from a third NF node;
transmitting, to a second NF node that serves the UE, a subscription report request for the event for the UE;
receiving, from a fourth NF node that currently serves the UE, a UE registration request for the UE, including an indication indicating whether the UE is in a restricted service area; and
determining whether to transmit a notification for the event to the third NF node based on the UE registration request.

48. The method of claim 47, wherein determining whether to transmit a notification for the event to the third NF node based on the UE registration request comprises:
transmitting a notification for the event to the third NF node when the UE registration request indicates that the UE is in an allowed service area.

49. The method of claim 47, wherein determining whether to transmit a notification for the event to the third NF node based on the UE registration request comprises:
prohibiting the transmission of the notification for the event to the third NF node when the UE registration request indicates that the UE is in a restricted service area or that a service area restriction is unknown for the UE.

50. The method of claim 49, further comprising:
receiving, from the fourth NF node, an update indication indicating that the UE is in an allowed service area; and
transmitting a notification for the event to the third NF node.

51. The method of claim 49, further comprising:
setting a flag indicating that the UE is in a restricted service area when the UE registration request indicates that the UE is in a restricted service area; and
processing subsequent requests related to terminating services towards the UE at least partially based on the flag.

52. The method of claim 51, further comprising:
clearing the flag when receiving, from the fourth NF node, an update indication indicating that the UE is in an allowed service area.

53. The method of claim 47, further comprising:
transmitting, to the fourth NF node, an indication indicating that the first NF node supports a service area restriction status feature.

54. The method of claim 47, wherein the fourth NF node is the second NF node when no change of serving NF node occurs due to UE mobility, and the fourth NF node is different from the second NF node when a change of serving NF node occurs due to UE mobility.

55. A method implemented at a first Network Function (NF) node for managing event subscription, the method comprising:
receiving, from a second NF node that serves a User Equipment (UE) a UE registration request including an indication indicating that service area restriction information for the UE is unknown; and
checking whether there is service area restriction information for the UE.

56. The method of claim 55, further comprising:
checking whether there is a subscription request of an event for the UE from a third NF node in response to there is no service area restriction information for the UE; and
transmitting a notification for the event to the third NF node.

57. The method of claim 55, further comprising:
transmitting, to the second NF node, an indication indicating that the first NF node supports service area restriction status feature in response to there is service area restriction information for the UE;
receiving, from the second NF node, an update indication indicating whether the UE is in a restricted service area; and
determining whether to transmit a notification for an event for the UE to a third NF node based on the update indication.

58. The method of claim 57, wherein determining whether to transmit a notification for the event for the UE to a third NF node based on the update indication comprises:
transmitting a notification for the event to the third NF node when the update indication indicates that the UE is in an allowed service area.

59. The method of claim 57, wherein determining whether to transmit a notification for the event for the UE to a third NF node based on the update indication comprises:
prohibiting the transmission of the notification for the event to the third NF node when the update indication indicates that the UE is in a restricted service area.

60. The method of claim 59, further comprising:
receiving, from the second NF node, an update indication indicating that the UE is in an allowed service area; and
transmitting a notification for the event to the third NF node.

61. The method of claim 57, further comprising:
when the update indication indicates that the UE is in a restricted service area, setting a flag indicating that the UE is in a restricted service area; and
processing subsequent requests related to terminating services towards the UE at least partially based on the flag.

62. The method of claim 61, further comprising:
clearing the flag when receiving, from the second NF node, an update indication indicating that the UE is in an allowed service area.

63. The method of claim 55, further comprising:
transmitting, to the second NF node, an indication indicating that the first NF node supports a service area restriction status feature.

64. A method implemented at a second Network Function (NF) node for managing event subscription, the method comprising:
receiving a UE registration request originated from a User Equipment (UE);
receiving, from a first NF node, a subscription report request of an event for the UE;
determining whether the UE is in a restricted service area; and
transmitting, to the first NF node, a UE registration request for the UE, including an indication indicating whether the UE is in a restricted service area.

65. The method of claim 64, further comprising:
determining whether the UE moves from an allowed service area to a restricted service area; and
transmitting an update indication to the first NF node indicating that the UE is in the restricted service area when it is determined that the UE moves from the allowed service area to the restricted service area.

66. The method of claim 64, further comprising:
determining whether the UE moves from a restricted service area to an allowed service area; and
transmitting an update indication to the first NF node indicating that the UE is in the allowed service area when it is determined that the UE moves from the restricted service area to the allowed service area.

67. The method of claim 65, further comprising:
receiving from the first NF node an indication indicating that the first NF node supports a service area restriction status feature, and
wherein transmitting, to the first NF node, the update indication, including an indication indicating whether the UE is in a restricted service area or in an allowed service area, is performed in response to a determination that the first NF node supports the service area restriction status feature.

68. A method implemented at a second Network Function (NF) node for managing event subscription, the method comprising:
receiving, from a first NF node, a subscription report request of an event for a User Equipment (UE) and
transmitting, to the first NF node, a UE registration request for the UE, the UE registration request including an indication indicating that service area restriction information for the UE is unknown.

69. The method of claim 68, further comprising:
receiving, from the first NF node, an indication indicating that the first NF node supports a service area restriction status feature and service area restriction information for the UE;
determining whether the UE is in a restricted service area based on the service area restriction information; and
transmitting to the first NF node an update indication indicating whether the UE is in a restricted service area.

70. The method of claim 69, further comprising:
determining whether the UE moves from an allowed service area to a restricted service area; and
transmitting an update indication to the first NF node indicating that the UE is in the restricted service area when it is determined that the UE moves from the allowed service area to the restricted service area.

71. The method of claim 69, further comprising:
determining whether the UE moves from a restricted service area to an allowed service area; and
transmitting an update indication to the first NF node indicating that the UE is in the allowed service area when it is determined that the UE moves from the restricted service area to the allowed service area.

72. The method of claim 68, wherein:
transmitting, to the first NF node, the update indication, including an indication indicating whether the UE is in a restricted service area or in an allowed service area, is performed in response to a determination that the first NF node supports the service area restriction status feature.
